(19) United States
(12) Patent Application Publication
(10) Pub. No.: US 2007/0124304 A1
(43) Pub. Date: May 31, 2007

(54) System and method for automatically retrieving information for a portable information system

(75) Inventors: Nevenka Dimitrova, Yorktown Heights, NY (US); Angel Janevski, New York, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/573,737

(22) PCT Filed: Sep. 28, 2004
(86) PCT No.: PCT/IB04/51901

§ 371 Date: Mar. 28, 2006

Related U.S. Application Data
(60) Provisional application No. 60/507,095, filed on Sep. 30, 2003.

(51) Int. Cl. G06F 17/30

(52) U.S. Cl. 707/10

(57) ABSTRACT

A system and method is provided for automatically retrieving information for a portable information system. The portable information system comprises an audio/video sensor that is capable of obtaining audio/video signals and a wireless communication device that is capable of communicating with a remotely located server to obtain information that is accessible by the server. The wireless communication device executes an automatic search procedure to cause the server to search for information that matches a search parameter that a user inputs to the portable information system. The server searches for the requested information in a plurality of databases that are located in a plurality of networks. An “image retrieval by example” search procedure and a “Web information extraction” search procedure are utilized.

The present invention is directed, in general, to audio-visual systems and, more specifically, to a system and method for automatically retrieving information for a portable information system.

Computer technology and wireless communication technology have been utilized to create portable electronic data devices that are capable of accessing and displaying information such as travel information for tourists. A typical prior art portable information system is disclosed in U.S. Pat. No. 6,023,241 entitled “Digital Multimedia Navigation Player/Recorder.” U.S. Pat. No. 6,023,241 describes a portable information system that comprises a digital camera, a digital data storage unit, and a global positioning system (GPS) receiver. The camera records video frames and/or audio data in association with global positioning system coordinates. A display screen is provided for displaying the video frames that are captured by the camera. The display screen also displays GPS information such as the current time and the current location of the GPS receiver.

The device also comprises a wireless communication link for communicating through a network system to a remotely located excursion server. The remotely located excursion server contains information concerning different travel excursions that may be taken by a tourist. Travel excursion information generally comprises a series of sequential locations, a map of a route connecting the locations, travel time from each location to the next location, and a description of significant points of interests concerning the individual locations. The portable information system accesses the remotely located excursion server to receive travel excursion information that may include, for example, a guided tour that includes images, global positioning system (GPS) coordinates, maps, and audio information.

The digital data storage unit of the prior art portable information system of U.S. Pat. No. 6,023,241 is also capable of storing multimedia data files such as video files, audio files and data files. These files may be displayed in association with each other to create a multimedia presentation of the travel excursion information. In this manner a multimedia presentation may be provided as a permanent record of a traveler's visit to a particular location or place. For example, a digital image of a landmark and an audio description of the landmark may be stored together with global positioning system (GPS) coordinates that locate the landmark.

Except for the global positioning system (GPS) coordinates, the multimedia input to the portable information system is entirely user-defined and entered. There is no interaction between the digital data storage unit of the portable information system and the tourist guide functions. In addition, the remotely located excursion server only downloads travel excursion information that has been previously stored in the excursion server.

There is therefore a need in the art for a system and method that is capable of automatically retrieving information for a portable information system. There is also a need in the art for a system and method that is capable of automatically retrieving information from a plurality of information resources that are located in geographically dispersed locations.

To address the deficiencies of the prior art mentioned above, the system and method of the present invention is capable of automatically retrieving information for a portable information system.

The portable information system of the present invention comprises an audio/video sensor that is capable of obtaining audio/video signals and a wireless communication device. The wireless communication device is capable of communicating with a remotely located server to obtain information that is located on the server or that is retrieved by the server from other information sources. The wireless communication device executes an automatic search procedure to cause the server to search for information that matches a search parameter that a user inputs to the portable information system. The server searches for the requested information in a plurality of databases that are located in a plurality of networks.

When the search parameter is a video image, the wireless communication device executes a video content retrieval procedure that utilizes a search procedure that is known as “image retrieval by example.” The “image retrieval by example” search procedure causes the server to locate at least one Web site that contains an image that matches the search parameter video image. The wireless communication device then executes a search procedure that is known as “Web information extraction.” This search procedure causes the server to locate additional information that relates to the search parameter video image.

To obtain travel information, the search parameter may be chosen to be a video image of a famous landmark. The invention automatically accesses information that relates to the landmark such as historical information, graphical information, artistic performances such as songs or poems, and URL addresses of other relevant Web sites. The portable information system may also comprise a location unit such as a global positioning system (GPS) receiver to provide accurate location information.

It is an object of the present invention to provide a system and method for automatically retrieving information for a portable information system.

It is another object of the present invention to provide a portable information system that is capable of executing a video content retrieval procedure that utilizes a search procedure that is known as “image retrieval by example.”

It is also an object of the present invention to provide a portable information system that is capable of executing a search procedure that is known as “Web information extraction.”

It is another object of the present invention to provide a portable information system that is capable of executing a search procedure that combines the “image retrieval by example” search procedure and the “Web information extraction” search procedure.

It is another object of the present invention to provide a portable information system that is capable of automatically locating travel information such as historical information, graphical information, artistic performances and the like for travel locations and landmarks.

It is also an object of the present invention to provide a portable information system that comprises an encyclopedia database that contains travel information and a travel history database that contains travel information for travel that occurred in the past.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the Detailed Description of the Invention, it may be advantageous to set forth definitions of certain words and phrases used throughout this patent document: the terms “include” and “comprise” and derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller,” “processor,” or “apparatus” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document. Those of ordinary skill in the art should understand that in many, if not most instances, such definitions apply to prior uses, as well as future uses, of such defined words and phrases.

For a more complete understanding of the present invention, and the advantages thereof, reference is now made to the following descriptions taken in conjunction with the accompanying drawings, wherein like numbers designate like objects, and in which:

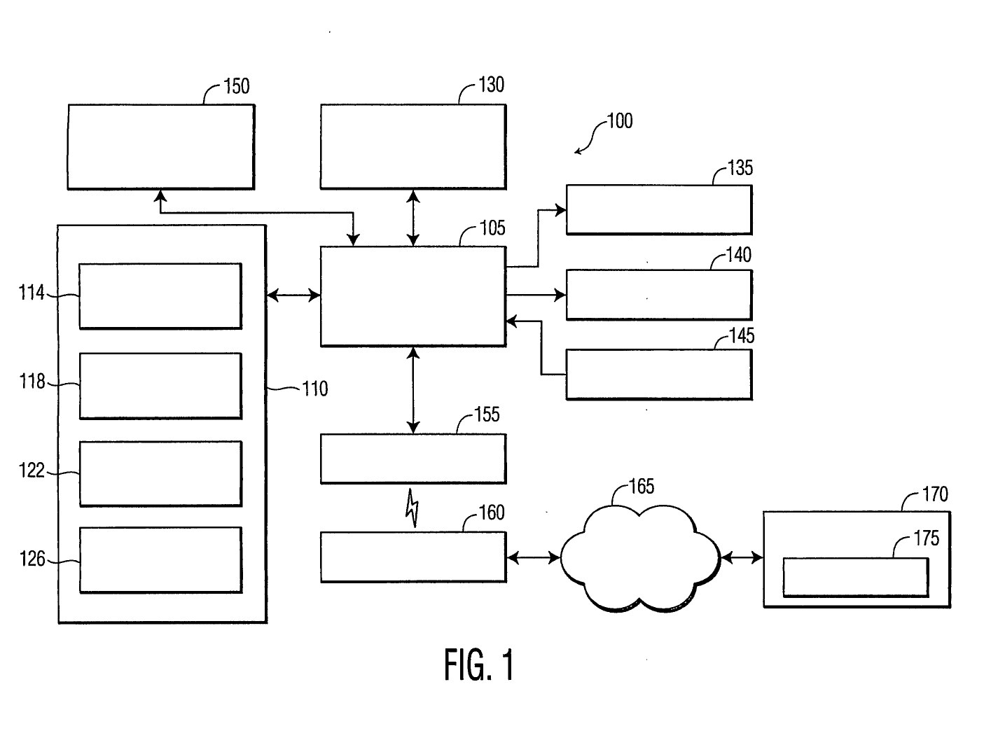

FIG. 1 is a block diagram illustrating a first advantageous embodiment of a portable information system in accordance with the principles of the present invention;

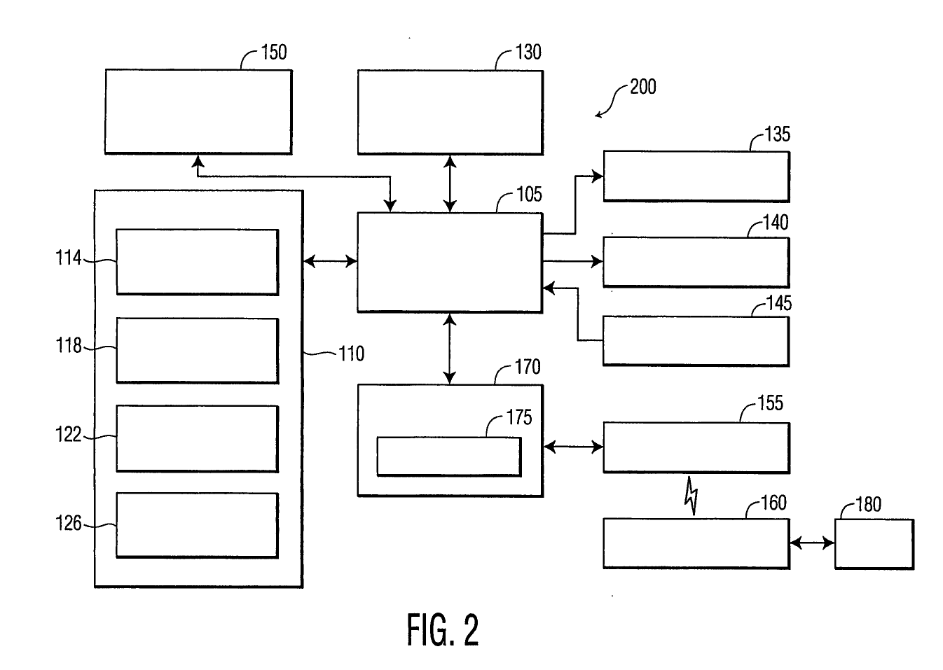

FIG. 2 is a block diagram illustrating a second advantageous embodiment of a portable information system in accordance with the principles of the present invention;

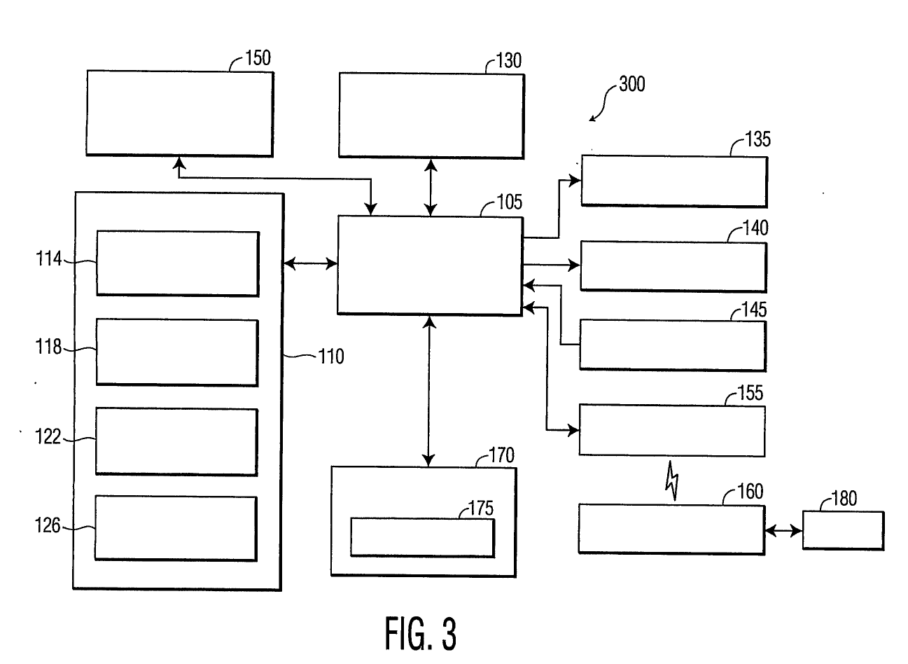

FIG. 3 is a block diagram illustrating a third advantageous embodiment of a portable information system in accordance with the principles of the present invention;

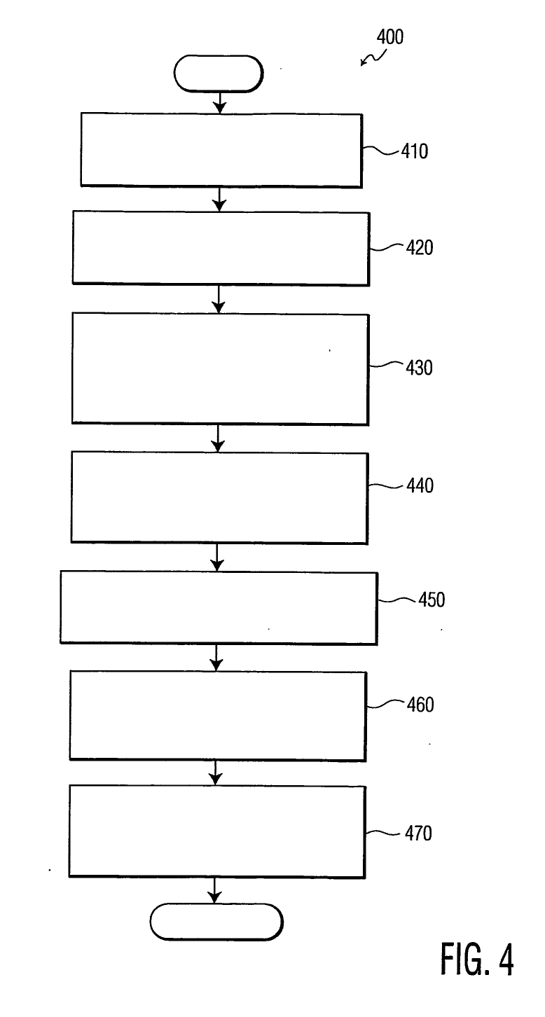

FIG. 4 illustrates a flowchart showing the steps of an advantageous embodiment of a first method of the invention; and

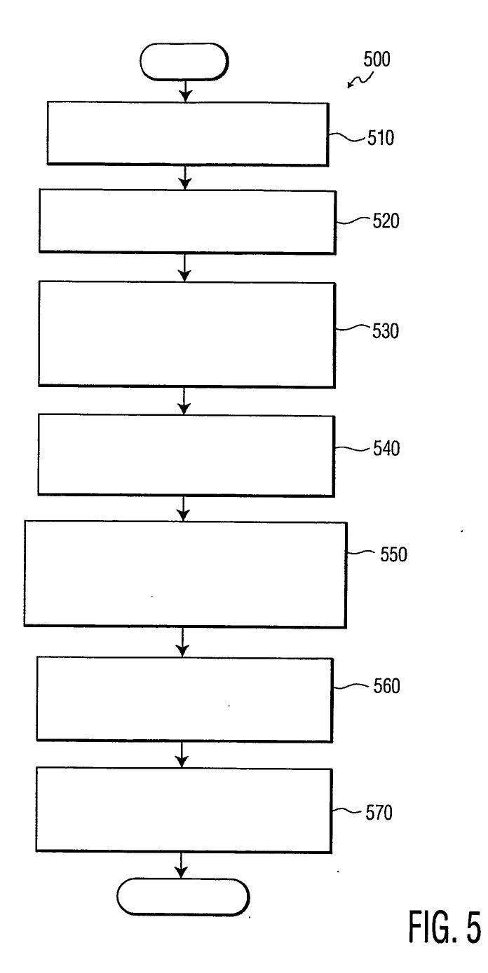

FIG. 5 illustrates a flowchart showing the steps of an advantageous embodiment of a second method of the invention.

FIGS. 1 through 5, discussed below, and the various embodiments used to describe the principles of the present invention in this patent document are by way of illustration only and should not be construed in any way to limit the scope of the invention. The present invention may be used in any suitable portable information system.

FIG. 1 is a block diagram illustrating a first advantageous embodiment of a portable information system 100 in accordance with the principles of the present invention. Portable information system 100 comprises a wireless communication device that comprises central processing unit (CPU) 105 and memory 110. Memory 110 contains systems operation software (not shown) for operating CPU 105 and the other elements of portable information system 100. Memory 110 also contains video content retrieval software 114, web information extraction software 118, encyclopedia database 122, and travel history database 126. The functions and operation of video content retrieval software 114, web information extraction software 118, encyclopedia database 122, and travel history database 126 will be explained more fully later in this patent document.

Portable information system 100 also comprises an audio/video sensor 130 that is capable of obtaining and recording audio/video signals. Audio/video sensor 130 may comprise, for example, a digital camera system. CPU 105 sends control signals to audio/video sensor 130 to operate audio/video sensor 130. The control signals may comprise such commands as: record signals, stop recording signals, record only audio signals, record only video signals, etc. Portable information system 100 also comprises an audio speaker 135, a video display 140, and user input units 145. User input units 145 may comprise any conventional source of user input signals (e.g., keyboard, keypad, mouse, touch screen, microphone, computer disk files).

Portable information system 100 also comprises a location unit 150 for obtaining information that gives a location for portable information system 100. Location unit 150 may comprise a Global Positioning System (GPS) receiver 150 that is capable of receiving satellite signals that give the location of portable information system 100. Alternatively, location unit 150 may comprise a unit that employs technology similar to the technology used for locating mobile telephones in a wireless communication system for cellular telephones. Location unit 150 continually provides location information to CPU 105 as the position of portable information system 100 changes.

Portable information system 100 also comprises a transceiver 155 that is capable of transmitting data signals to a remote location and that is capable of receiving data signals from a remote location. In the embodiment portable information system 100 shown in FIG. 1 a transceiver 160 at a remote location receives transmissions from transceiver 155 of portable information system 100. The transmissions from transceiver 155 may comprise requests for information that have been sent by CPU 105. Transceiver 160 is coupled a server 170 through a network 165 (e.g., the Internet). Transceiver 160 forwards information requests from CPU 105 through network 165 to server 170.

Server 170 may access one or more databases to search for the information requested by CPU 105. An exemplary database 175 is shown in FIG. 1 located within server 170. It is understood that server 170 may access more than one database and that the databases need not be located within server 170. Server 170 is capable of searching for information throughout network 165 (and throughout other networks that are not shown in FIG. 1). When server 170 finds the information requested by CPU 105, server 170 sends the information back to transceiver 160 through network 165. Transceiver 160 then transmits the information back to transceiver 155 and transceiver 155 sends the information to CPU 105.

FIG. 2 is a block diagram illustrating a second advantageous embodiment of portable information system 200 in accordance with the principles of the present invention. In the second embodiment of portable information system 200, server 170 and database 175 are not located at a remote site but are contained within portable information system 200. Information requests from CPU 105 go to server 170. Server 170 is able to access at least one remotely located server 180 through transceiver 155 and transceiver 160 in the manner previously described. It is understood that server 180 may be coupled to one or more databases (not shown in FIG. 2) and also coupled to one or more networks (not shown in FIG. 2).

FIG. 3 is a block diagram illustrating a third advantageous embodiment of portable information system 300 in accordance with the principles of the present invention. In the embodiment of portable information system 300 shown in FIG. 3 the server functionality may be divided among a plurality of servers in which at least one server 170 is located within portable information system 300 and at least one server 180 is located at a remote location in the manner previously described. It is understood that server 180 may be coupled to one or more databases (not shown in FIG. 3) and also coupled to one or more networks (not shown in FIG. 3).

The operation of the portable information system of the present invention will be described with respect to the first advantageous embodiment 100 of the portable information system. Assume that the user of portable information system 100 is visiting a famous landmark in a foreign city. To access information concerning the landmark the user takes a picture of the landmark with the digital camera system 130. The user then enters a command to CPU 105 via one of the user input units 145 to tell CPU 105 that the picture of the landmark is a search parameter. The user then commands CPU 105 to perform a search for information relating to the landmark in the picture.

In response to the user's command, CPU 105 executes video content retrieval software 114 to perform the requested search. Video content retrieval software 114 automatically performs the requested search using a search procedure that is known as “image retrieval by example.” Techniques for carrying out a search using “image retrieval by example” are discussed in U.S. Pat. No. 6,163,622 entitled “Image retrieval system”, U.S. Pat. No. 6,285,995 entitled “Image retrieval system using a query image.” These two patents are both owned by the assignee of the present invention and are hereby incorporated by reference for all purposes.

Video content retrieval software 114 causes server 170 to search network 165 (e.g., Internet 165) and locate Web sites that contain the image of the landmark that video content retrieval software is using as a search parameter.

When video content retrieval software 114 has completed its search, it returns the results of the search to CPU 105. Then CPU 105 displays the results of the search to the user on video display 140. The results of the search typically take the form of a list of Web sites that contain an image that matches the image of the landmark of the search parameter. In one advantageous embodiment of the invention, the list of Web sites is ranked so that the Web site with the “best” image match is listed first.

The user then reviews the list of Web sites and selects one of the Web sites (usually the Web site with the “best” image match) for further processing. The user then sends a command to CPU 105 to request CPU 105 to search for additional information that relates to the image of the landmark in the selected Web site. In an alternate embodiment of the invention, CPU 105 automatically searches for additional information for each Web site in the list of Web sites in descending order of relevance.

Whether automatically or in response to a user command, CPU 105 executes Web information extraction software 118 to perform the additional search Web information extraction software 118 automatically performs the search using a search procedure that is known as “Web information extraction.” Techniques for carrying out a search using “Web information extraction” based on user queries are discussed in United States Patent Application No. 2002/0144293 entitled “Automatic Video Retriever Genie.” This patent application is owned by the assignee of the present invention and is hereby incorporated herein by reference for all purposes. Web information extraction software 118 causes server 170 to search network 165 (e.g., Internet 165) and locate additional information that relates to the Web site that Web information extraction software 118 is using as a search parameter.

The linking to external information using “Web information extraction” can also be used to access non-travel information that is associated in some way with the location. For example, a traveler to Buenos Aires in Argentina can use the portable information system 100 of the present invention to access a relevant poem by Jorge Luis Borges in which the city of Buenos Aires is mentioned. The portable information system 100 of the present invention not only capable of providing travel information but is also capable of providing additional cultural materials that enrich the traveler's experience.

Web information extraction software 118 is capable of obtaining various types of information. For example, Web information extraction software 118 may obtain historical information concerning the landmark. The historical information may be in the form of an audio presentation, a video presentation, or a text presentation. Web information extraction software 118 may obtain graphical information concerning the landmark such as a map that shows the area surrounding the landmark. The graphical information may also comprise maps that show the location of historical events that occurred near the landmark. If the landmark is a building or similar structure, the graphical information may also comprise blueprints or structural drawings of the building. Web information extraction software 118 may also obtain artistic performances that feature the landmark such as songs, poems, lectures, and the like. Web information extraction software 118 may also obtain URL addresses of Web sites that relate to the landmark.

The results of the Web information extraction search procedure may comprise structured data that has been extracted from various Web sites. For example, a search result for a building may contain information that sets forth the year or years during which the building was constructed, the identity of the builder or architect, the history of the building, the precise location of the building, referenced entities, historical points of interest, and tourist information. The structure of the search results, the rules for extraction and the locations from which the information has been extracted can be a part of the search service and can be appropriately updated and enhanced by the search service provider.

Web information extraction software 118 is also capable of searching encyclopedia database 122 in memory 110. Encyclopedia database 122 contains a plurality of digital data files that represent audio files, video files and data files that contain travel information in which the user has an interest. Encyclopedia database 122 serves as a repository of travel information. Travel information may be downloaded by the user directly into encyclopedia database 122 from any source of digital data. The travel information in encyclopedia database 122 may relate to places that the user has not yet visited. The travel information in encyclopedia database 122 may also be travel information that the user has previously collected during the user's travels. It is understood that non-travel information may also be stored in encyclopedia database 122.

When Web information extraction software 118 has completed its search, it returns the results of the search to CPU 105. Then CPU 105 displays the results of the search to the user on video display 140. The user can then cause CPU 105 to display any digital data file that was located by Web information extraction software 118. In this manner the user can acquire extensive amounts of information concerning the landmark that was the subject of the search. CPU 105 also updates encyclopedia database 122 with the information that was obtained by Web information extraction software 118.

Portable information system 100 is also provided with an optional location unit 150 such as a global positioning system (GPS) receiver 150. Location information from GPS receiver 150 may be associated with the other search result information obtained by video content retrieval software 114 and Web information extraction software 118.

In an alternate advantageous embodiment of portable information system 100, the search parameter for the search may be a word instead of a visual image. The user provides the search word parameter to CPU 105 by speaking the search word into a microphone in one of the user input units 145. Techniques for carrying out a search using a search word as a search parameter are discussed in the previously referenced United States Patent Application No. 2002/0144293.

Portable information system 100 provides a system and method for automatically retrieving tourist information. Unlike prior art systems, portable information system 100 is not limited to searching a limited number of travel excursion databases in a limited number of travel excursion servers. The search techniques employed by portable information system 100 enables a server to create search agents that “crawl” the Web searching for the latest and freshest information. Also unlike prior art systems, portable information system 100 provides a system and method for automatic image retrieval and for automatic information extraction of related information.

The user can also instruct CPU 105 to store selected digital data files in a portion of memory 110 entitled travel history database 126. Travel history database 26 contains the user's personal collection of travel information, which may include location information, the user's commentary, and any other type of information that the user desires to store. The travel history database 26 serves as an archive of information that relates to travels that the user has taken in the past. At any time the user can “relive” those travels by displaying the stored files. The travel history database 26 serves as a multimedia memory of past travels including images, retrieved information and personal comments. In addition, the user can cause CPU 105 to re-execute the search procedures at a later time to update the stored information or obtain additional or up-to-date details from a wider range of sources.

The ability to update information may also be used to overcome bandwidth restrictions. For example, the wireless communication bandwidth is likely to be restricted when portable information system 100 is being used outdoors. The bandwidth is likely to be greater indoors (e.g., in a hotel room). Portable information system 100 can therefore be set to retrieve just the basic information at an outdoor location. Portable information system 100 can be instructed to keep a buffer of tasks to be performed overnight when there is more time and a wider bandwidth available.

As shown in FIG. 1, the server functionality for the present invention may reside on a remotely located server 170. As shown in FIG. 2, the server 170 may reside within the portable information system 200. As shown in FIG. 3, the server functionality may be divided between the two locations. That is, server 170 in portable information system 300 performs part of the server function and server 180 also performs part of the server functionality.

FIG. 4 illustrates a flowchart showing the steps of an advantageous embodiment of a first method of the invention. The steps of the method shown in FIG. 4 are collectively referred to with reference numeral 400. In the first step, a user provides a video image search parameter to CPU 105 (step 410). CPU 105 then executes the video content retrieval software 114 to perform an “image retrieval by example” search (step 420). During the search process server 170 searches network 165 (e.g., Internet 165) and finds Web sites that contain the video search parameter (step 430). CPU 105 presents the search results to the user and the user selects one of the Web sites that contain the video search parameter for further processing (step 440).

CPU 105 then executes Web information extraction software 118 for the selected Web site (step 450). CPU 105 then provides the results of the Web information extraction search process to the user (step 460). CPU 150 then updates encyclopedia database 122 with the results of the Web information extraction search process (step 470).

FIG. 5 illustrates a flowchart showing the steps of an advantageous embodiment of a second method of the invention. The steps of the method shown in FIG. 5 are collectively referred to with reference numeral 500. In the first step, a user provides a video image search parameter to CPU 105 (step 510). CPU 105 then executes the video content retrieval software 114 to perform an “image retrieval by example” search (step 520). During the search process server 170 searches network 165 (e.g., Internet 165) and finds Web sites that contain the video search parameter (step 530). CPU 105 then automatically ranks each Web site in descending order of relevance (step 540).

CPU 105 then automatically executes Web information extraction software 118 for each Web site in descending order of relevance (step 550). CPU 105 then provides the results of the Web information extraction search process to the user (step 560). CPU 150 then updates encyclopedia database 122 with the results of the Web information extraction search process (step 570).

While the present invention has been described in detail with respect to certain embodiments thereof, those skilled in the art should understand that they can make various changes, substitutions modifications, alterations, and adaptations in the present invention without departing from the concept and scope of the invention in its broadest form.

1. A portable information system (100) comprising:
an audio/video sensor (130) that is capable of obtaining audio/video signals; and
a wireless communication device (105) associated with said audio/video sensor (100) that is capable of communicating with a remotely located server (170) to obtain information that is accessible by said server (170);
wherein said wireless communication device (105) is capable of executing an automatic search procedure (114,118) to cause said server (170) to search for information that relates to a search parameter that a user inputs to said portable information system (100); and
wherein said server (170) searches for said information in a plurality of databases that are located in a plurality of networks (165).

2. A portable information system (100) as claimed in claim 1 wherein said search parameter is a video image and wherein said automatic search procedure (114,118) that is executed by said wireless communication device (105) comprises a video content retrieval procedure (114) that utilizes a search procedure that is known as image retrieval by example.

3. A portable information system (100) as claimed in claim 2 wherein said search procedure (114,118) that is executed by said wireless communication device (105) causes said server (170) to locate at least one Web site that contains an image that matches said search parameter video image.

4. A portable information system (100) as claimed in claim 3 wherein said wireless communication device (105) one of:
receives an input from said user to select a Web site from a list of Web sites located by said search procedure, wherein each Web site in said list of Web sites contains an image that matches said search parameter video image; and
automatically selects a Web site from a list of Web sites located by said search procedure, wherein each Web site in said list of Web sites contains an image that matches said search parameter video image.

5. A portable information system (100) as claimed in claim 4 wherein said automatic search procedure (114,118) that is executed by said wireless communication device (105) further comprises a search procedure that is known as Web information extraction (118); and
wherein said wireless communication device (105) executes said Web information extraction procedure (118) on said selected Web site to obtain additional information from said server (170) that relates to said search parameter video image.

6. A portable information system (100) as claimed in claim 5 wherein said additional information comprises one of: an audio presentation, a video presentation, a text presentation, historical information, graphical information, an artistic performance, and URL information.

7. A portable information system (100) as claimed in claim 5 wherein said wireless communication device (105) further comprises:
a location unit (150) that is capable of providing location information to said wireless communication device (105).

8. A portable information system (100) as claimed in claim 5 wherein said wireless communication device (105) further comprises:
an encyclopedia database (122) that is capable of containing travel information; and
a travel history database (126) that is capable of containing travel information that relates to travels that a user has taken in the past.

9. A portable information system (100) as claimed in claim 1 wherein said search parameter is a word and wherein said automatic search procedure (114,118) that is executed by said wireless communication device comprises a word content retrieval procedure (114,118).

10. A portable information system (200) as claimed in claim 1 wherein said wireless communication device further comprises an internally located server (170).

11. A method of automatically retrieving information for a portable information system (100), said method comprising the steps of:
obtaining audio/video signals in an audio/video sensor (130);
utilizing a wireless communication device (105) associated with said audio/video sensor (130) to communicate with a remotely located server (170) to obtain information that is accessible by said server (170);
inputting a search parameter into said portable information system (100);
executing an automatic search procedure (114,118) in said wireless communication device (100) to cause said server (170) to search for information that relates to said search parameter in a plurality of databases (175) that are located in a plurality of networks (165); and
receiving in said wireless communication device (105) information located by said server (170) that relates to said search parameter.

12. The method as claimed in claim 11 wherein said search parameter is a video image and wherein said automatic search procedure that is executed by said wireless communication device comprises a video content retrieval procedure that utilizes a search procedure that is known as image retrieval by example.

13. The method as claimed in claim 12 wherein said search procedure that is executed by said wireless communication device causes said server to locate at least one Web site that contains an image that matches said search parameter video image.

14. The method as claimed in claim 13 further comprising the step of one of:
receiving in said wireless communication device an input from said user to select a Web site from a list of Web sites located by said search procedure, wherein each Web site in said list of Web sites contains an image that matches said search parameter video image; and
receiving in said wireless communication device a Web site automatically selected by said wireless communication device from a list of Web sites located by said search procedure, wherein each Web site in said list of Web sites contains an image that matches said search parameter video image.

15. The method as claimed in claim 14 wherein said automatic search procedure (114,118) that is executed by said wireless communication device (105) further comprises a search procedure that is known as Web information extraction (118); and wherein said method further comprises the step of:
executing said Web information extraction procedure (118) on said selected Web site to obtain additional information from said server that relates to said search parameter video image.

16. The method as claimed in claim 15 wherein said additional information comprises one of: an audio presentation, a video presentation, a text presentation, historical information, graphical information, an artistic performance, and URL information.

17. The method as claimed in claim 15 further comprising the step of:
providing location information to said wireless communication device (105).

18. The method as claimed in claim 15 further comprising the steps of:
providing said wireless communication device with an encyclopedia database that is capable of containing travel information; and
providing said wireless communication device with a travel history database that is capable of containing travel information that relates to travels that a user has taken in the past.

19. The method as claimed in claim 11 wherein said search parameter is a word and wherein said automatic search procedure that is executed by said wireless communication device comprises a word content retrieval procedure.

20. The method as claimed in claim 11 wherein said wireless communication device further comprises an internally located server, and wherein said method further comprises the steps of:
executing said automatic search procedure in said wireless communication device to cause said internally located server to search for information that relates to said search parameter within at least one database located within said wireless communications device; and
receiving in said wireless communication device information located by said internally located server that relates to said search parameter.
